(19) United States
(12) Patent Application Publication
(10) Pub. No.: US 2016/0371166 A1
(43) Pub. Date: Dec. 22, 2016

(54) STREAM-BASED BREAKPOINT FOR TOO MANY TUPLE CREATIONS

(71) Applicant: International Business Machines Corporation, Armonk, NY (US)

(72) Inventors: Eric L. BARSNESS, Pine Island, MN (US); Michael J. BRANSON, Rochester, MN (US); John M. SANTOSUOSSO, Rochester, MN (US)

(21) Appl. No.: 14/744,388

(22) Filed: Jun. 19, 2015

(51) Int. Cl. G06F 11/36

(52) U.S. Cl. CPC G06F 11/362

(57) ABSTRACT

Techniques are disclosed for inserting breakpoints during debugging of a streams processing environment. A distributed application of the streams processing environment has a plurality of processing elements executing in a runtime environment. A debugger monitors a count of tuples output from each processing element. For each processing element, the debugger compares the count of triples output from the processing element against a specified count of tuples. Upon determining that the count of tuples that are output from the processing element is outside of a specified range of tuples to be output from the processing element, a breakpoint is inserted at the processing element.

### BACKGROUND

Embodiments presented herein generally relate to debugging, and more specifically, to identifying, for debugging purposes, an unexpected amount of output from a distributed streams application.

In a streams processing environment, multiple nodes in a computing cluster execute a distributed application. The distributed application retrieves a stream of input data from a variety of data sources and analyzes the stream. A stream is composed of data units called “tuples,” which is a list of values. Further, the distributed application includes processing elements that are distributed across the cluster nodes. Each processing element includes one or more operators configured to perform a specified task associated with a tuple. Each processing element receives one or more tuples as input and processes the tuples through the operators. Once performed, the processing element may output one or more resulting tuples to another processing element. Which in turn performs a specified task on those tuples, and so on.

A developer for the distributed application may design an operator graph using an integrated development environment (IDE) tool. The operator graph specifies a desired configuration of processing elements in the streams processing, environment. The developer may define functions for each processing, element to perform via the operator graph. The functions can specify a given task to perform and a destination processing element for tuple output. Further, the IDE tool may provide a debugger that allows the developer to ensure that the distributed application executes in the streams processing environment as specified.

One embodiment presented herein describes a method. The method includes monitoring, via a debuger for a distributed application, the distributed application having a plurality of processing elements executing in a runtime environment, a count of tuples output from each processing element. For each processing element, the count of tuples output from the processing element is compared against a specified count of tuples. Upon determining that the count of tuples that are output from the processing element is outside of a specified range of tuples to be output from the processing element, a breakpoint is inserted at the processing element.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE SEVERAL VIEWS OF THE DRAWINGS

FIG. 1 illustrates an example computing environment, according to one embodiment.

FIG. 2 further illustrates the distributed application described relative to FIG. 1, according to one embodiment.

FIG. 3 illustrates an example operator graph, according to one embodiment.

FIG. 4 illustrates an example processing element, according to one embodiment.

FIG. 5 fluffier illustrates the debugger described relative to FIG. 1 according to one embodiment.

FIG. 6 illustrates a method for identifying an unexpected amount of output from processing elements of a distributed application, according to one embodiment.

FIG. 7 illustrates a computing system configured to identify an unexpected amount of output from processing elements of a distributed application, according to one embodiment.

### DETAILED DESCRIPTION

Embodiments presented herein describe techniques for identifying, via a debugger, unexpected amounts of data being output between elements of a distributed application. In one embodiment, a distributed application executes in a computing cluster in a streams processing environment. Processing elements of the distributed application execute in cluster nodes and retrieve streams of input in data units called “tuples,” or a list of input values. Each processing element includes one or more operators that process the tuples and output resulting tuples to other processing elements. A developer may compose, through an integrated development environment (IDE) tool, an operator graph that specifies a desired configuration of processing elements and operators in the streams processing environment.

In one embodiment, the IDE tool includes a debugger that allows the developer to identify and address issues arising in the distributed application. Occasionally, in the streams processing environment, a processing element (or operator within the processing element) may output an anomalous amount of tuples to another processing element (operator). For example, a developer may design a processing element intending that processing element to output between five to ten tuples within a given timeframe. However, the developer may observe that during runtime of the streams processing environment, the processing element is actually outputting fifty topics within that timeframe. As another example, the developer may intend that a given processing element outputs ten tuples to another processing element. However, the developer may observe that the processing element only outputs two tuples. Such anomalies could be due to human coding errors, the nature of the data being input, an attack on the streams processing environment, or some other cause.

In one embodiment, the debugger identifies instances where a processing, element (or operator) outputs an unexpected amount of tuples. The debugger may then insert breakpoints at each of the identified instances. Doing so may assist a developer in diagnosing a cause of the unexpected number of tuples being output by a processing element. To identify such instances during debugging, the IDE tool may initiate runtime of the streams processing environment in a debug mode. During execution, the debugger monitors a flow of tuples being output from each processing element. The debugger may evaluate an amount of tuples output by each processing element against a specified amount of tuples expected to flow from the processing element within a given time period. Such a specified amount may be a range of amounts, a low amount threshold, a high amount threshold, and so on, within a given time period. Further, a range of amounts can be based on a relationship between two ports of a processing element, in the event that a processing element has multiple ports. For instance, for each tuple that a port A outputs, a port B outputs a corresponding tuple.

At each breakpoint, the debugger may capture information that allows the developer to identify a cause of the unexpected amount of tuples, such as an amount of tuples created per operator within the processing element, the flow of a given tuple through the operator graph, and the like.

Advantageously, embodiments described herein provide data-driven techniques for analyzing a cause of anomalous amounts of output from an element of a distributed application. That is, rather than break at a given point based on a line of application code, the debugger breaks at an instance where a given processing element outputs an unexpected amount of tuples. Because the debugger provides information associated with the instance, a developer may more easily identify a cause of the unexpected amount of tuples being output from the processing element.

Note, the following references a distributed application of a streams processing environment as a reference example of an application executing in a cluster of computing nodes, where processing elements in each node perform some task that results in data being output to other processing elements. However, one of skill in the art will recognize that embodiments presented herein may be adapted to a variety of applications having components that output variable but expected amounts of data to other destinations.

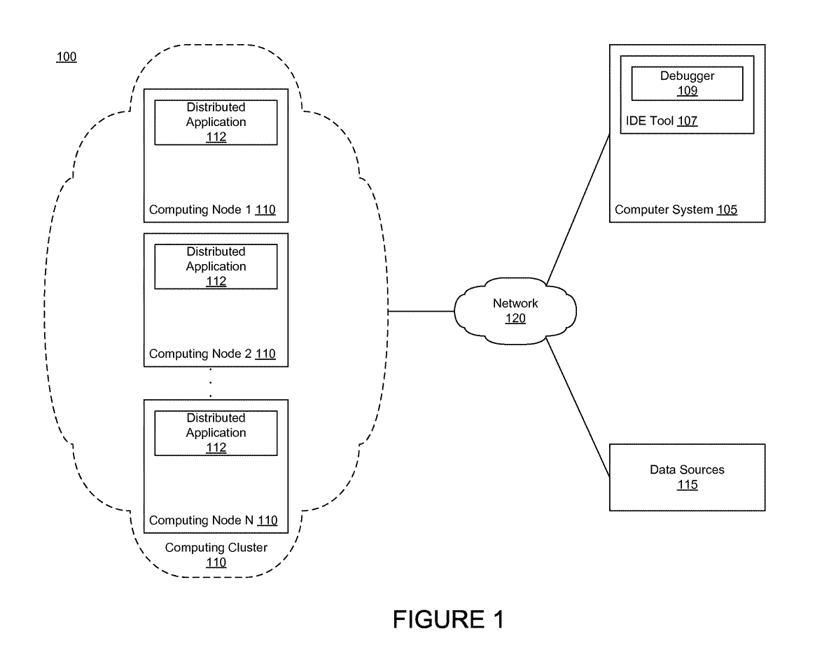

FIG. 1 illustrates an example computing environment 100, according to one embodiment. As shown, computing environment 100 includes a computing cluster 105, a computer system 110, and one or more data sources 115. The computing cluster 105, computing system 110, and data sources 115 are each connected via a network 120 (e.g., the Internet).

In one embodiment, the computing cluster 105 includes multiple computing nodes 107. Each computing node may be a physical computing system or a virtual machine instance executing in a cloud computing environment. The nodes 107 each execute a distributed application 109. The distributed application 109 retrieves input streams of data from various data sources 115, e.g., over the network 120. Examples of such data include message data, XML documents, biometric data captured from an individual in real-time, etc. The distributed application 109 analyzes the input streams in manageable data units called “tuples.” A tuple is a list of values. Further, the distributed application 109 includes processing elements executing on various nodes that perform a specified task using triples as input. Tuples flow from processing element to processing element in the streams processing environment.

The computer system 110 may be a physical computing system or a virtual machine instance in a cloud environment. In one embodiment, the computer system 110 includes an integrated development environment (IDE) tool 112. A developer in the streams processing environment may configure processing elements via the IDE tool 112, e.g., to specify which particular node(s) to execute a given processing element, to specify a function of a given processing element, to specify a flow of tuples between processing elements, etc. Further, the IDE tool 112 includes a debugger 113. The debugger 113 allows the developer to pinpoint anomalies that occur during runtime of the streams processing environment. For example, the debugger 113 can insert breakpoints at instances where a given processing element crashes, sends data to an unintended target processing element, etc. Further, in one embodiment, the debugger 113 may insert breakpoints at instances where a given processing element (or operator) outputs an anomalous amount of triples to another processing element (or operator).

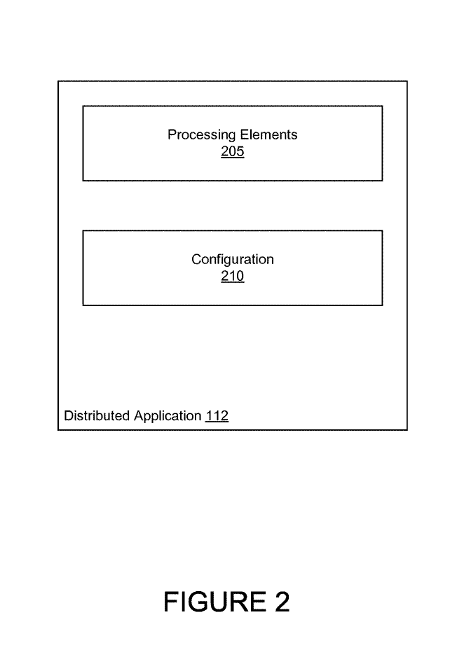

FIG. 2 further illustrates the distributed application 109, according to one embodiment. As shown, the distributed application 109 includes one or more processing elements 205 and a configuration 210.

As stated, processing elements 205 may be distributed to various nodes in the computing cluster 105. Each processing element 205 includes one or more operators. Each operator may perform a specified task associated with a data workload. For example, one operator may receive a tuple that consists of comma-delineated text values. The operator may determine the number of times a given term appears in the tuple and send the result to another operator, in addition to other specified information.

The configuration 210 specifies properties of the streams processing environment. For example, such properties may describe which node a given processing element 205 is located, a specified flow of data between processing elements 205, address information of each node, identifiers for processing elements 205, and the like.

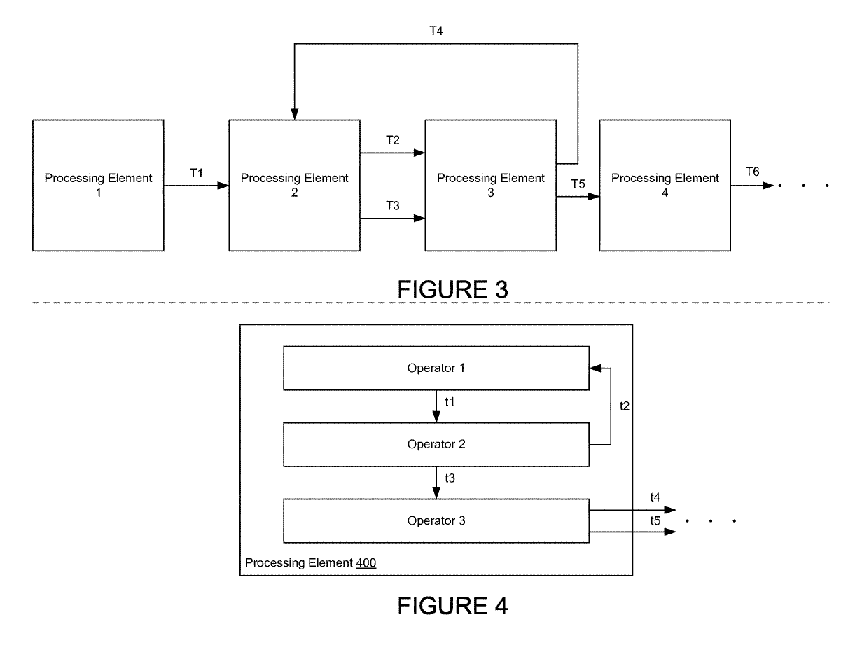

FIG. 3 illustrates an example operator graph 300, according to one embodiment. As stated a developer can configure processing elements through an operator graph using the IDE tool 107. For example, the IDE tool 107 allows the developer to determine in which nodes to place each processing element, functions that each operator in the processing element performs, tuple destination processing elements, etc.

In this example, FIG. 3 depicts four processing elements 1-4. Illustratively, each processing element outputs tuples (T1-T6) to other processing elements. For example, processing element 1 outputs a tuple T1 to processing element 2. Processing element 2 performs a specified function on the tuple T1 and outputs tuples 12 and 13 to processing element 3. Further, processing elements may output triples to different destination processing elements. As illustrated, processing element 3 outputs tuple 14 to processing element 2 and tuple T5 to processing element 4.

FIG. 4 illustrates an example processing element 400, according to one embodiment. As shown, the processing element 400 includes operators 1, 2, and 3. Illustratively, tuples t1-t5 flow from each operator to destination operators or to destination processing elements. Multiple tuples may flow from a given operator or processing element. One issue that may arise is an unexpectedly high amount of tuples flowing from a given operator or processing element.

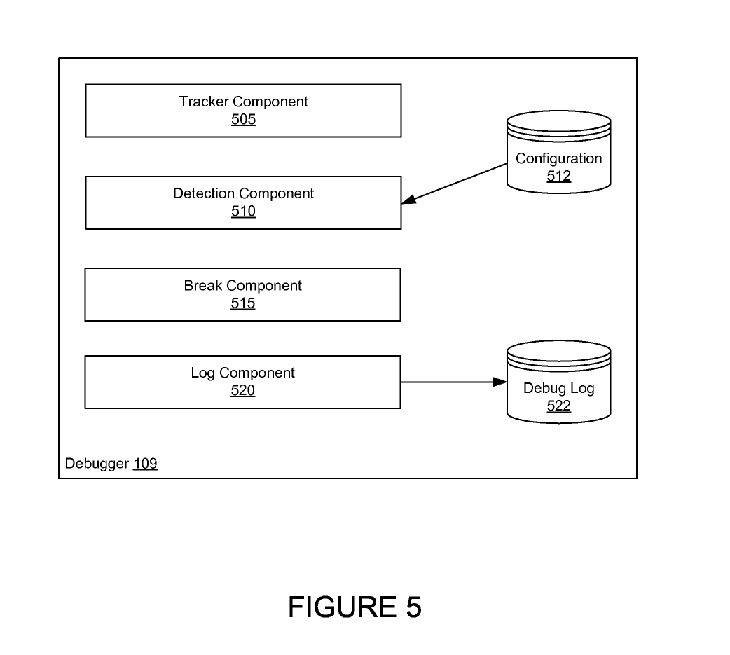

FIG. 5 further illustrates the debugger 109, according to one embodiment. As shown, the debugger 109 includes a tracker component 505, a detection component 510, a configuration 512, a break component, log component 520, and debug log 522.

In one embodiment, the tracker component 505 monitors each tuple that flows from a given processing element and operator. The tracker component 505 maintains a count of tuples flowing from the processing element and operator. Further, the tracker component 505 associates each output tuple with the processing element and operator of origin.

The detection component 510 identifies instances where a processing element outputs an abnormal amount of tuples. To do so, the detection component 510 may evaluate a tuple count within a time period specified in the configuration 512. The detection component 510 may compare the count with an expected value, range, or threshold specified in the configuration 512. For example, assume that a processing element is expected to output five to ten tuples within a time period. The detection component 510 might observe that the processing element actually outputs fifteen. In such a case, the detection component 510 identifies the processing element as outputting an abnormal amount of tuples.

The break component 515 inserts a breakpoint at an identified instance where a processing element outputs an abnormal amount of tuples. Further, the break component 515 captures information associated with the instance, such as a processing element identifier, operator identifier, amount of tuples output, and the like. The log component 520 may store such information in a debug log 522.

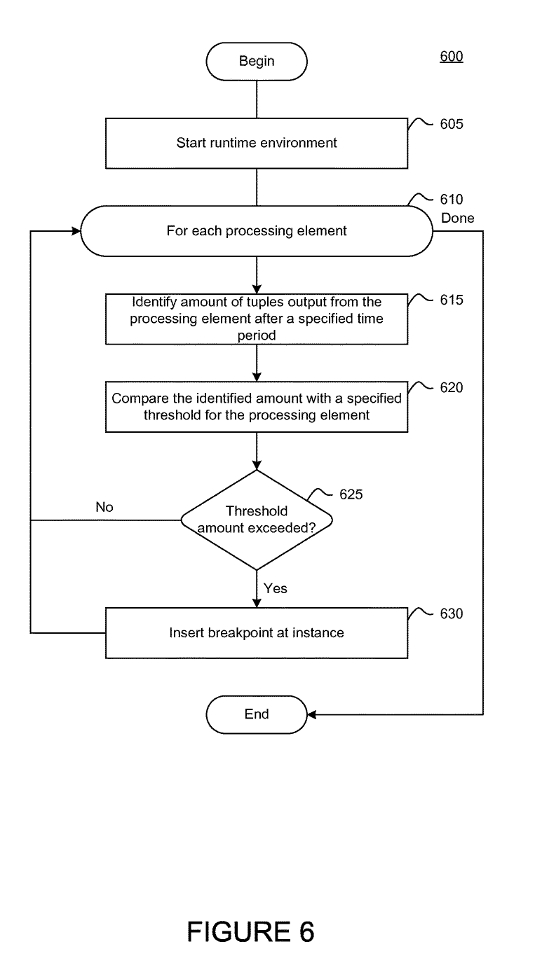

FIG. 6 illustrates a method 600 for identifying an unexpected amount of output from processing elements of a distributed application, according to one embodiment. As shown, method 600 begins at step 605, where the distributed application 605 initiates the runtime environment. During execution of the runtime environment, the tracking component 505 monitors the flow of tuples from the processing elements.

At step 610, for each processing element, the debugger 109 performs the following actions. At step 615, the tracker component 505 identifies an amount of tuples that are output from the processing element after a specified time period. At step 620, the detection component 510 compares the identified amount with a threshold amount for that processing element. For example, assume that a processing element is expected to output approximately thirty tuples within the time period. The threshold may be set at or near that amount. Further, assume that the processing element actually outputs seventy tuples.

At step 625, the detection component 510 determines whether the actual output amount exceeds the threshold amount. If not, then the debugger 109 iterates through the next processing element. Continuing the previous example, the processing element actually outputs seventy tuples, which exceeds the threshold. In such a case, at step 630, the break component 515 inserts a breakpoint at the processing element. The break component 515 may capture information such as identifiers for associated processing elements and operators, flow information of the tuples, and the like. Further, the log component 520 may record such information in a debug log.

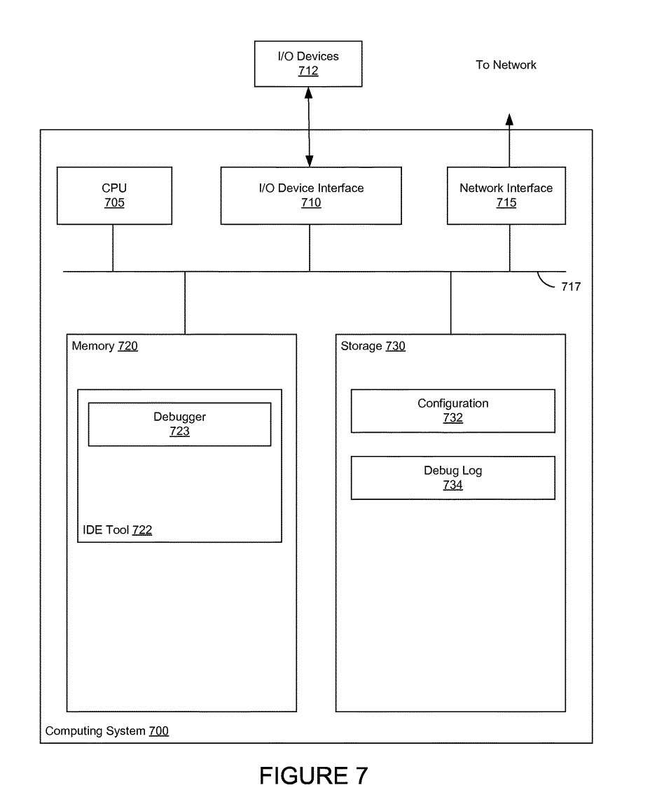

FIG. 7 illustrates a computing system 700 configured to identify an unexpected amount of output from processing elements of a distributed application, according to one embodiment. As shown, the computing system 700 includes, a central processing unit (CPU) 705, a network interface 715, a memory 720, and storage 730, each connected to a bus 717. The computing system 700 may also include an 110 device interface 710 connecting I/O devices 712 (e.g., keyboard, display and mouse devices) to the computing system 700. Further, in context of this disclosure, the computing elements shown in the computing system 700 may correspond to a physical computing system.

CPU 705 retrieves and executes programming instructions stored in memory 720 as well as stores and retrieves application data residing in the storage 730. The bus 717 is used to transmit programming instructions and application data between CPU 705, devices interface 710, storage 730, network interface 717, and memory 720. Note, CPU 705 is included to be representative of a single CPU, multiple CPUs, a single CPU having multiple processing cores, and the like. Memory 720 is generally included to be representative of a random access memory. Storage 730 may be a disk drive storage device. Although shown as a single unit, storage 730 may be a combination of fixed and/or removable storage devices, such as fixed disc drives, removable memory cards, or optical storage, network attached storage (NAS) or a storage area-network (SAN).

Illustratively, memory 720 includes an integrated development environment (IDE) tool 722. And storage 630 includes a configuration 732 and a debug log 734. A developer uses the IDE tool 722 to design processing elements and operators in a streams processing environment. The IDE tool 722 itself includes a debugger 723. The debugger 723 inserts breakpoints at instances where a given processing element crashes, sends data to an unintended target processing element, etc. Further, in one embodiment, the debugger 113 may insert breakpoints at instances where a given processing element outputs an anomalous amount of tuples to another processing element. To do so, the debugger 723 may track tuples and maintain a count of tuples flowing through the streams processing environment. Further, the debugger 723 can evaluate the tuple amounts flowing out of a given processing element against an expected amount or range. If the actual amount exceeds (or falls below) the amount or range, then the debugger 723 inserts a breakpoint at that instance. The debugger 723 may also record information associated with the instance in the debug log 734.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction, execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud.” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the IDE tool and debugger) or related data available in the cloud. For example, the IDE tool and debugger could execute on a computing system in the cloud and track counts of triples being output by processing elements in the streams processing environment. In such a case, the debugger could break at instances where a processing element outputs an unexpected amount of triples to a destination processing element and store a log of such instances at a storage location in the cloud. Doing so allows a developer to access this information from any computing system attached to a network connected to the cloud (e.g., the Internet).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium of to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the Uses computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specific the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block of blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

1.-8. (canceled)

9. A computer program product, comprising:
a computer-readable storage medium having computer-readable program code embodied therewith, the computer-readable program code configured to perform an operation comprising:
monitoring, via a debugger for a distributed application, the distributed application having a plurality of processing elements executing in a runtime environment, a count of tuples output from each processing element, and for each processing element:
comparing the count of tuples output from the processing element against a specified count of tuples, and
upon determining that the count of tuples that are output from the processing element is outside of a specified range of tuples to be output from the processing element, inserting a breakpoint in the processing element.

10. The computer program product of claim 9, wherein the operation further comprises, for each processing element:
upon determining the count of tuples output from the processing element falls below a minimum count for the processing element, inserting a breakpoint in the processing element.

11. The computer program product of claim 9, wherein the operation further comprises, for each processing element:
upon determining that the count of tuples output from the processing element exceeds the specified count, inserting a breakpoint in the processing element.

12. The computer program product of claim 9, wherein the distributed application processes one or more data streams.

13. The computer program product of claim 9, wherein the operation further comprises:
obtaining properties associated with the processing elements; and
displaying the properties in an IDE application.

14. The computer program product of claim 12, wherein the properties further include a flow of tuples through the processing elements and an expected flow of tuples through the processing elements.

15. A system, comprising:
a processor; and
a memory storing a program, which, when executed on the processor, performs an operation comprising:
monitoring, via a debugger for a distributed application, the distributed application having a plurality of processing elements executing in a runtime environment, a count of tuples output from each processing element, and for each processing element:
comparing the count of tuples output from the processing element against a specified count of tuples, and
upon determining that the count of tuples that are output from the processing element is outside of a specified range of tuples to be output from the processing element, inserting a breakpoint in the processing element.

16. The system of claim 15, wherein the operation further comprises, for each processing element:
upon determining the count of tuples output from the processing element falls below a minimum count for the processing element, inserting a breakpoint in the processing element.

17. The system of claim 15, wherein the operation further comprises, for each processing element:
upon determining that the count of tuples output from the processing element exceeds the specified count, inserting a breakpoint in the processing element.

18. The system of claim 15, wherein the distributed application processes one or more data streams.

19. The system of claim 15, wherein the operation further comprises:
obtaining properties associated with the processing elements; and
displaying the properties in an IDE application.

20. The system of claim 19, wherein the properties include an overall amount of tuples being output by each of the processing elements, a flow of tuples through the processing elements and an expected flow of tuples through the processing elements.
